(19) United States
(12) Patent Application Publication
(10) Pub. No.: US 2003/0046171 A1
(43) Pub. Date: Mar. 6, 2003

(54) Systems and methods for determining special pricing of components for printing device customers

(76) Inventor: Margo N. Whale, Kuna, ID (US)

Correspondence Address: HEWLETT-PACKARD COMPANY, Intellectual Property Administration, P.O. Box 272400, Fort Collins, CO, 80527-2400, US

(21) Appl. No.: 09/942,296

(22) Filed: Aug. 29, 2001

(51) Int. Cl. G06F 17/60

(52) U.S. Cl. 705/26

(57) ABSTRACT

Systems and methods for providing purchase incentives to printing device replaceable component customers, the purchase incentives being based on a printing device usage rate for the customer. A replaceable component vendor maintains a page count over a time period for each replaceable component customer. A printing device usage rate is calculated from these values. When a new replaceable component is ordered, a vendor system calculates the printing device usage for the customer and refers to a pricing table to determine the price. When a replaceable component with component memory is returned to the vendor, a page count is read from the component memory and is added to the page count for the customer for use in determining a price discount.

### TECHNICAL FIELD

This invention generally relates to marketing printing device replaceable components for printing device customers and, more particularly, to determining special printing device replaceable component pricing for printing device customers having a high printer usage rate.

### BACKGROUND

Most types of printing devices are equipped with replaceable components that have a life cycle during which the replaceable components are functional. At the end of the life cycle of a replaceable component, the component must be replaced for the printing device to continue to function properly.

For example, a toner cartridge is installed in a laser printer to provide toner for the printing process. As documents are printed, the toner supply is gradually depleted. When the toner supply is completely exhausted, the printer cannot print any further documents until the toner cartridge is replaced. An owner of the printer must now look to purchase a replacement toner cartridge for the printer.

There is a multitude of manufacturers and vendors of toner cartridges that vie for the opportunity to sell replacement toner cartridges to those printer owners having such a need. Because it is vitally important to reach these potential customers, virtually every marketing avenue has been taken advantage of to contact printer owners and induce them to purchase the vendor's replacement toner cartridges.

One way to persuade printer owners to purchase particular replacement toner cartridges (and other replacement consumables) is to provide an incentive to the printer owner. Such an incentive typically involves a monetary savings for the printer owner. For example, a vendor may maintain an incentive whereby a printer customer may purchase a toner cartridge for half of the regular price after the customer has already purchased three other toner cartridges.

In addition, a consumables vendor may offer an incentive to potential customers that benefit the vendor by helping to reduce costs incurred by the vendor. For example, a vendor may be able to save money by handling transactions via the Internet rather than by more conventional printed means because the vendor can save on printing materials, postage, etc. In this instance, the vendor may offer some sort of incentive to potential customers to purchase replaceable printer components via the Internet, e.g., faster delivery, lower cost, valuable coupons for future purchases, rebates, etc.

Incentive marketing programs like those described above must typically be created to a large number of printer owners. A marketing program having a capability to create, track and monitor incentive programs for individual printer owners would be very valuable to printer consumables vendors because, among other things, the added flexibility would enable vendors to identify and target marketing efforts to particular individuals or enterprises.

### SUMMARY

Systems and methods are described herein for providing purchase incentives to potential customers of printing device replaceable components. The purchase incentives are in the form of special pricing of printing device replaceable components based on the printing device usage of a customer. High-use customers are offered replaceable components at a lower price than are lower-use customers.

To achieve such a pricing incentive program, the systems and methods described herein have the capability to track printing device usage for each of several customers. This means that no matter how many printing devices are owned by a customer, the total usage for that customer is tracked. As a result, customers having several to hundreds of printing devices will probably have a higher usage than a customer having only one or a few printing devices.

In one implementation, a printing device replaceable component vendor maintains a database that includes information for each customer that purchases goods from the vendor. A cumulative page count for each customer is kept in the database. When a customer orders a replaceable component from the vendor, the vendor can access the cumulative page count and determine a price for each component ordered by the customer based on the cumulative page count. For example, if the cumulative page count indicates that the customer averages printing 25,000 pages per month, the price structure for the ordered components may be lower than if the usage was less.

Printing device replaceable components that have component memory integrated therewith may be used to track the page counts. When a component with component memory is returned to the vendor for recycling, a page count is read from the component memory that indicates how many pages were printed using the depleted component. This page count is added to the cumulative total for the customer that returned the depleted component and the cumulative total is used to calculate printing device usage. Use of components with component memory provides a process for tracking printing device usage that is more accurate and convenient than other methods.

In one described implementation, a high-use pricing incentive plan is integrated with an automatic ordering system that automatically orders replacement components for printing devices when a replaceable component for a printing device fails, is depleted or requires replacement for another reason. In such an automatic ordering system, a replacement component is ordered from the vendor. The vendor calculates the price based on a cumulative page count and printing device usage. When the component is returned to the vendor for recycling, a page count is read and added to the cumulative total. This page count may affect a future transaction.

The printing device usage is used to discount currently ordered replaceable components and to provide an incentive for ordering replaceable components in the future. For discounting currently ordered components, a customer receives information about the program and repeatedly sends components back to a vendor for recycling, knowing that the customer may receive a discount on an ordered component if printer usage is at or above a certain rate. Incentives are offered to potential customers or to each customer that returns a component for recycling. The incentive may vary, but typically it informs the customer that if the customer purchases so many components within a particular future time period, the cost of the components will be reduced.

The benefits provided by the systems and methods described herein are lower transaction costs for vendors, more direct targeting of potential customers, higher sales volumes, higher customer retention, etc. In addition, a customer having several printing devices gets credit for the customer's total usage rather than the customer's usage per printing device.

### BRIEF DESCRIPTION OF THE DRAWINGS

The present invention is illustrated by way of example and not limitation in the figures of the accompanying drawings. The same numbers are used throughout the figures to reference like components and/or features.

FIG. 1 is a block diagram of a laser printer suitable for use with the high-usage pricing systems and methods described herein.

FIG. 2 is an illustration of a laser printer toner cartridge that has memory incorporated therewith.

FIG. 3 is a block diagram of a system for implementing the high-usage pricing systems and methods described herein.

FIG. 4 depicts a printing device usage database suitable for use in the systems and methods described herein.

FIG. 5 depicts a history database suitable for use in the systems and methods described herein.

FIG. 6 depicts a pricing table suitable for use in the systems and methods described herein.

FIG. 7 is a flow diagram depicting a method for offering pricing incentives to printing device replaceable component customers having a high printing device usage rate.

### DETAILED DESCRIPTION

The following description sets forth one or more specific implementations and/or embodiments of systems and methods for determining special pricing of printing device replaceable components based on customer printing device usage. The systems and methods incorporate elements recited in the appended claims. These implementations are described with specificity in order to meet statutory written description, enablement, and best-mode requirements. However, the description itself is not intended to limit the scope of this patent.

Also described herein are one or more exemplary implementations of systems and methods for determining special pricing of printing device replaceable components based on customer printing device usage. Applicant intends these exemplary implementations to be examples only. Applicant does not intend these exemplary implementations to limit the scope of the claimed present invention(s). Rather, Applicant has contemplated that the claimed present invention(s) might also be embodied and implemented in other ways, in conjunction with other present or future technologies.

Computer-Executable Instructions

An implementation of a system and/or method for determining special pricing of printing device replaceable components based on customer printing device usage may be described in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Computer-Readable Media

An implementation of a system and/or method for automatically tracking the order status of an automatically ordered replaceable component for a printing device may be stored on or transmitted across some form of computer-readable media. Computer-readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communications media” typically embodies computer-readable instructions, data structures, program modules, or other data in a modulated data signal, such as carrier wave or other transport mechanism. Communication media also includes any information delivery media.

Exemplary Printing Device

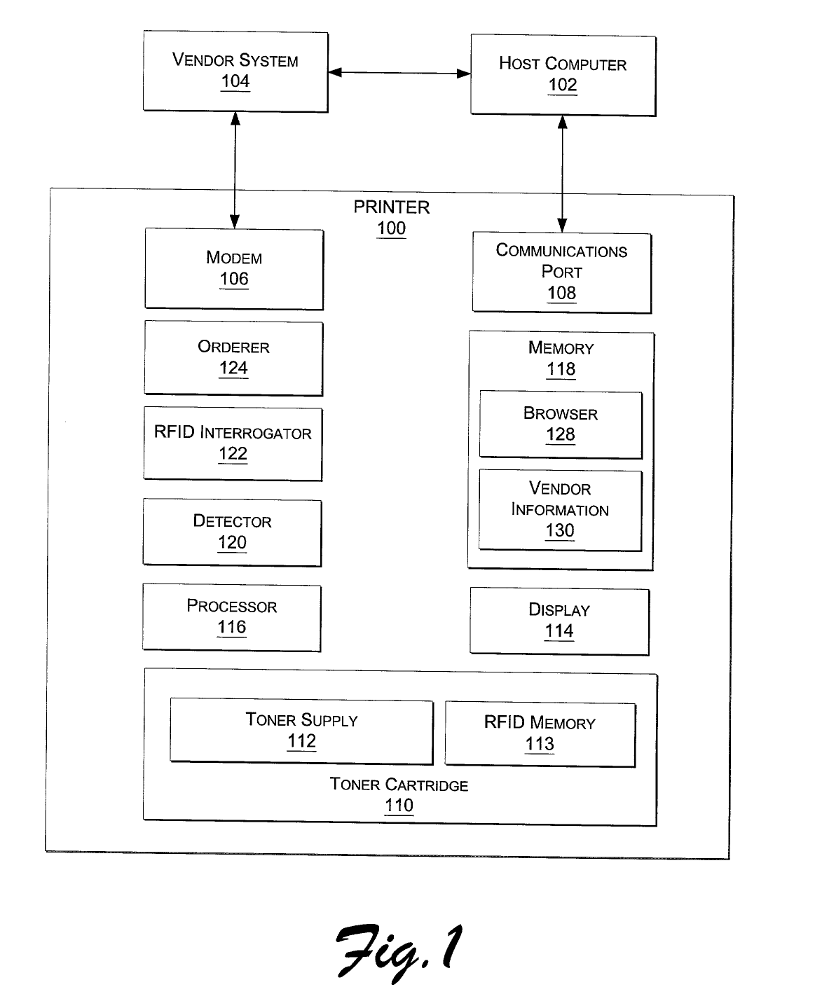

FIG. 1 is a block diagram of a laser printer 100 constructed in accordance with one implementation of the high-usage incentive pricing system described herein. Although the present discussion describes the laser printer 100, it is noted that the high-usage incentive pricing system described herein may be included with any type of printing device—such as an inkjet printer, a facsimile machine, a copy machine, etc.—that utilizes replaceable components. It is noted that the laser printer 100 and the high-usage incentive pricing system is described in the context of a laser printer that includes an automatic component ordering system. However, it is noted that the systems and methods described herein may be implemented on a similar system that does not have automatic replaceable component ordering capability and that describing the invention(s) in such a context is not intended to limit the scope of the appended claims. Also, it will be recognized by those skilled in the art that many of the features shown in the laser printer 100 and/or the functions performed by those features may be implemented as software modules, hardware devices and/or a combination thereof.

Also shown in FIG. 1 is a host computer 102 that is connected to and communicates with the laser printer 100, and a vendor system 104 that communicates with the laser printer 100 and the host computer 102. The host computer 102 and the vendor system 104 are utilized with an automatic component ordering system as well as with the high-usage incentive pricing systems and methods described herein. The function of the host computer 102 and the vendor system 104 will become apparent as the high-usage incentive pricing system is described in greater detail below.

The laser printer 100 includes a modem 106 and a communications port 108. The modem 106 is configured to access and communicate with the vendor system 104. The communications port 108 is a parallel port through which the laser printer 100 communicates with the host computer 102, although it could be any port to which the host computer 102 may be connected.

The laser printer 100 also includes a replaceable toner cartridge 110 that has a toner supply 112 stored therein. The toner cartridge 110 has radio frequency identification (RFID) memory 113 incorporated therewith. Although the present discussion will focus on the replacement of the toner cartridge 110, it is noted that the invention described herein is suitable for use related to any replaceable component that is used in the laser printer 100. The laser printer is equipped with an RFID interrogator 122 through which the laser printer 100 can read from and write to the RFID memory 113 of the toner cartridge 110.

The laser printer 100 further includes a display 114, a processor 116 and memory 118. A detector 120 is included that is configured to detect when a replaceable component in the laser printer 100 is nearing or has reached the end of its functional life cycle. For the present discussion, the detector 120 is a low toner detector 120 that detects when the toner supply 112 of the toner cartridge 110 has reached a depletion level indicating that a replacement toner cartridge (not shown) should be ordered to replace the toner cartridge 110. The detector 120 is shown located in the laser printer 100 itself, although the detector 120 may be integrated into the toner cartridge 110.

The laser printer 100 also includes an orderer 124 that is configured to receive a notice from the detector 120 that the toner supply 112 in the toner cartridge 110 is low. Upon receipt of the notice, the orderer 124 automatically contacts the vendor system 104 either directly using the modem 106 or by way of the Internet (not shown) using a browser 128 stored in the memory 118. It is noted that when the present invention is implemented on a printing device that does not have a browser, then the described features are implemented by utilizing a browser (not shown) included in the host computer 102.

The memory 118 of the laser printer 100 also stores vendor information 130 that includes data about the vendor system 104, e.g., name, address, e-mail address, remote access number, etc., for a vendor from which replaceable components may be ordered. The orderer 124 uses the vendor information 130 to contact the vendor system 104 and place an order for a printing device replaceable component.

Exemplary Printing Device Replaceable Component

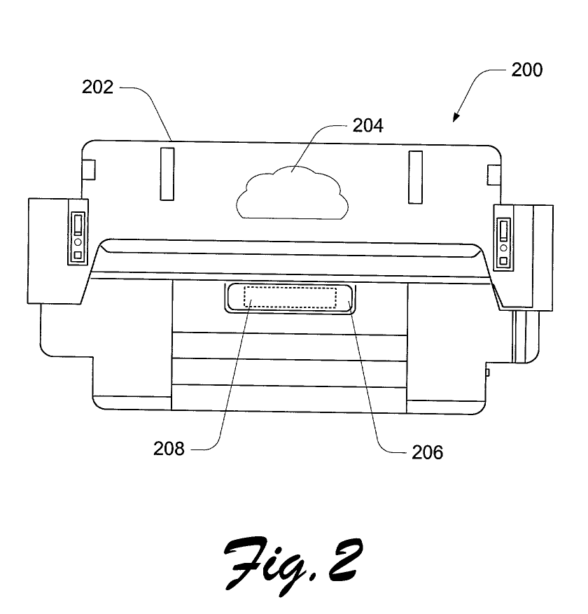

FIG. 2 is an illustration of a toner cartridge 200 that is installable in the laser printer 100 depicted in FIG. 1 and is suitable for use in the high-use incentive pricing system described herein. Although the invention is shown and described herein utilizes a printer toner cartridge for a laser printer, it is noted that the invention may be utilized with any replaceable component (toner cartridge, ink cartridge, imager drum, fuser, etc.) installable in a printing device (printer, copier, fax machine, etc.). The toner cartridge 200 includes a cartridge body 202 that contains a toner supply 204.

A memory tag 206 is located underneath a label 208 on the toner cartridge 200, although the memory tag 206 may be placed on the toner cartridge 200 at any location which may be practical for the purposes described herein. The memory tag 206 is preferably a radio frequency identification (RFID) memory tag. RFID memory tags and applications therefor are well known in the art. Further aspects of the functionality of the RFID memory tag 206 in the present invention(s) will become more clear as the discussion progresses.

Exemplary High-Usage Incentive Pricing System

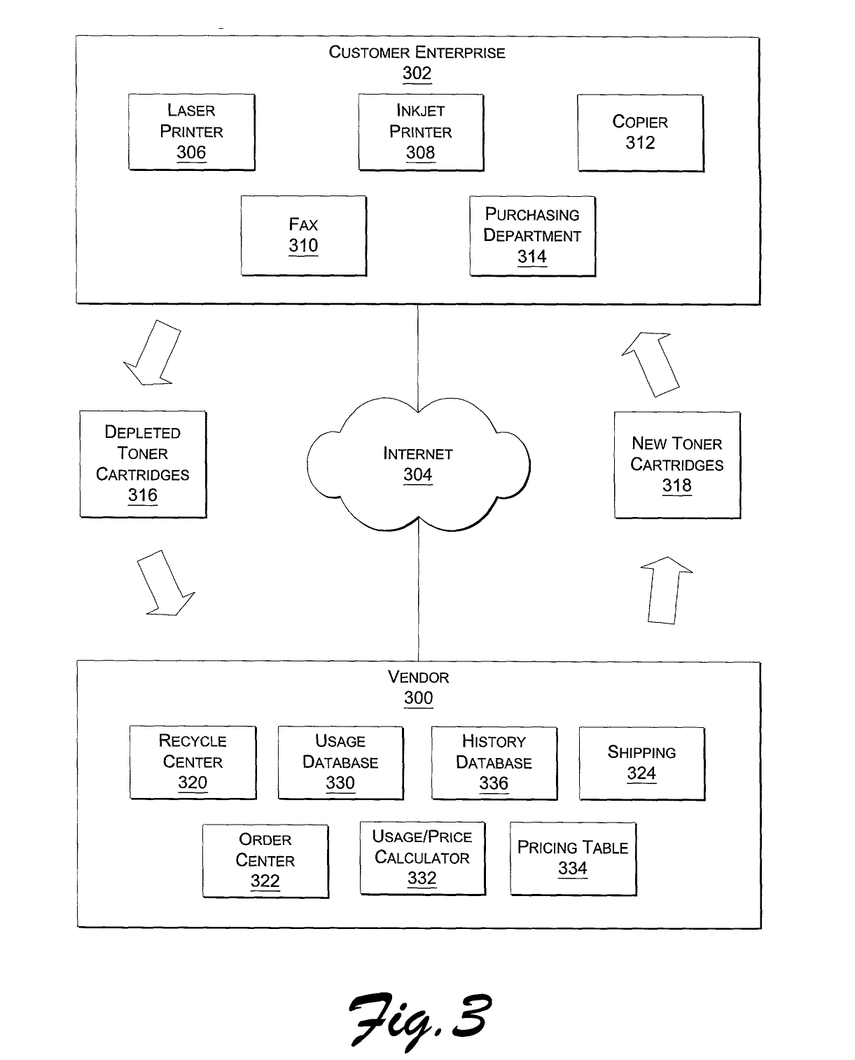

FIG. 3 is a block diagram of a vendor 300 and a customer enterprise 302 for implementing the high-usage pricing systems and methods described herein. The vendor 300 and the customer enterprise 302 communicate with one another via the Internet 304. The customer enterprise 302 includes a number of printing devices that utilize replaceable components including a laser printer 306, an inkjet printer 308, a fax 310 and a copier 312. The customer enterprise 302 also includes a purchasing department 314 that controls the purchase of replaceable components for use in the printing devices 306-312 owned by the customer enterprise 302. Depleted toner cartridges 316 are returned by the customer enterprise 302 to the vendor 300, and new toner cartridges 318 are shipped by the vendor 300 to the customer enterprise 302.

The vendor 300 includes a recycle center 320 that receives depleted components 316 from the customer enterprise 302, an order center 322 that receives orders for components from the customer enterprise 302, and a shipping department 324 that is responsible for shipping ordered components 318 to the customer enterprise 302. The vendor 300 also includes a usage database 330, a usage/price calculator 332, a pricing table 334 and a history database 336. The structure and function of these components is described in greater detail below.

It is noted that at least one (and possibly more) of the elements 320-336 included with the vendor 300 may be implemented in a computing system (not shown). The computing system is not shown in FIG. 3 so as not to limit the configuration of the high-use incentive pricing system. There are several vendor configurations alternatives that may be utilized, such as whether a computing system integrates the order center 322 or not. Those skilled in the art will recognize appropriate alternatives to use in particular situations.

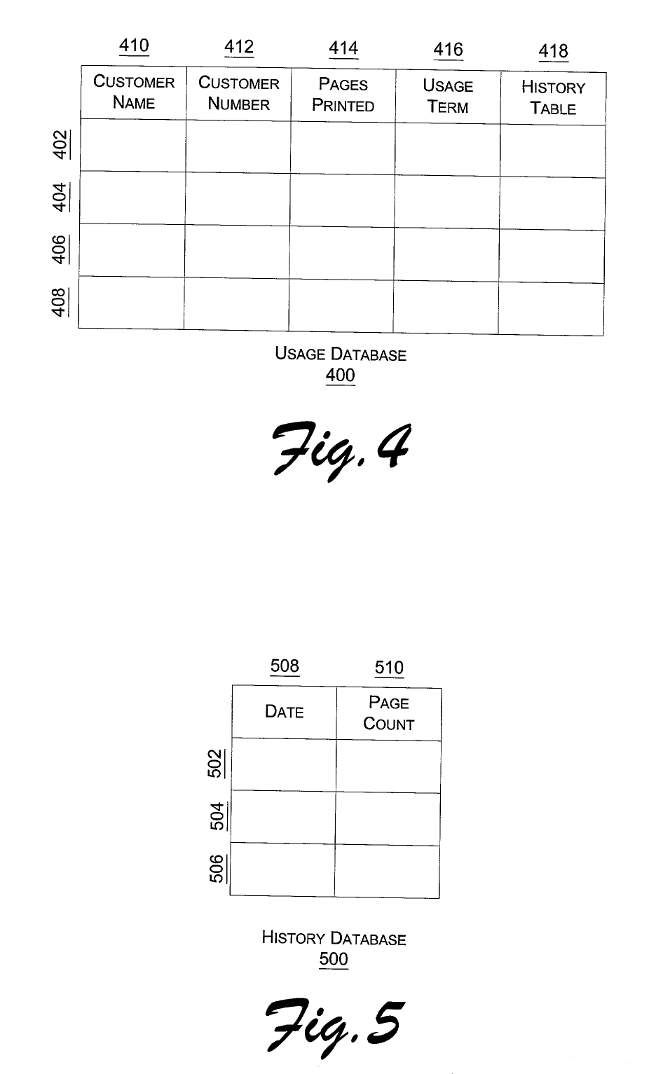

Exemplary configurations of the usage database 330, the pricing table 334 and the history database 336 are described below as shown in FIGS. 4-6. The function of the elements shown in FIG. 3 will be discussed in greater detail with respect to the exemplary method described below with regard to FIG. 7.

Exemplary Data Structures

FIG. 4 depicts an exemplary usage database 400 that is suitable for use with the high-usage incentive pricing systems and methods described herein. The usage database 400 includes several records 402-408 that contain several fields 410-418. Each of the records 402-408 are associated with a particular customer (not shown). Each record 402-408 includes the same fields 410-418. A customer name field 410 stores the name of a customer. A customer number field 412 stores a value that uniquely identifies the customer identified in the associated customer name field 410. A pages printed field 414 contains a number of pages printed by the customer identified in the associated customer name field 410. The pages printed field 414 only stores the number of pages printed from printing devices of a particular brand. For example, if Hewlett-Packard is the vendor, then the pages printed field 414 would contain the number of pages printed from H-P printing devices or H-P components in printing devices.

The usage database 400 also includes a usage term field 416. The usage term field 416 contains a value that indicates a time period over which printer usage for the customer identified in the associated customer name field 410 is calculated. For example, if the vendor decides to base pricing incentives on a “pages per month” average over the previous twelve months, then the usage term field 416 would store a value of “12.” In this way, the vendor can be flexible when creating a pricing incentive program.

A history database field 418 contains a reference, or pointer, to a history database associated with the customer identified in the associated customer name field 410. The history database field 418 is optional and is maintained so a vendor can use historical numbers for statistical and marketing purposes, if desired.

FIG. 5 depicts an exemplary history database 500 that is suitable for use with the high-usage incentive pricing systems and methods described herein. The history database 500 includes several records 502-506. Each record 502-526 represents a date on which a page count was received from a customer. Each record 502-506 of the history database 500 includes a date field 508 and a page count field 510. The date field 508 contains a date on which a page count in the page count field 510 was received.

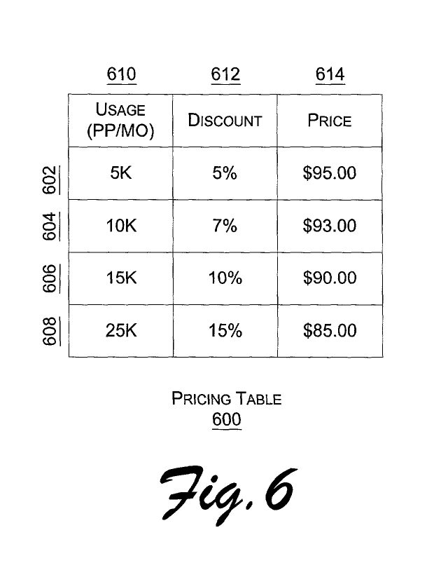

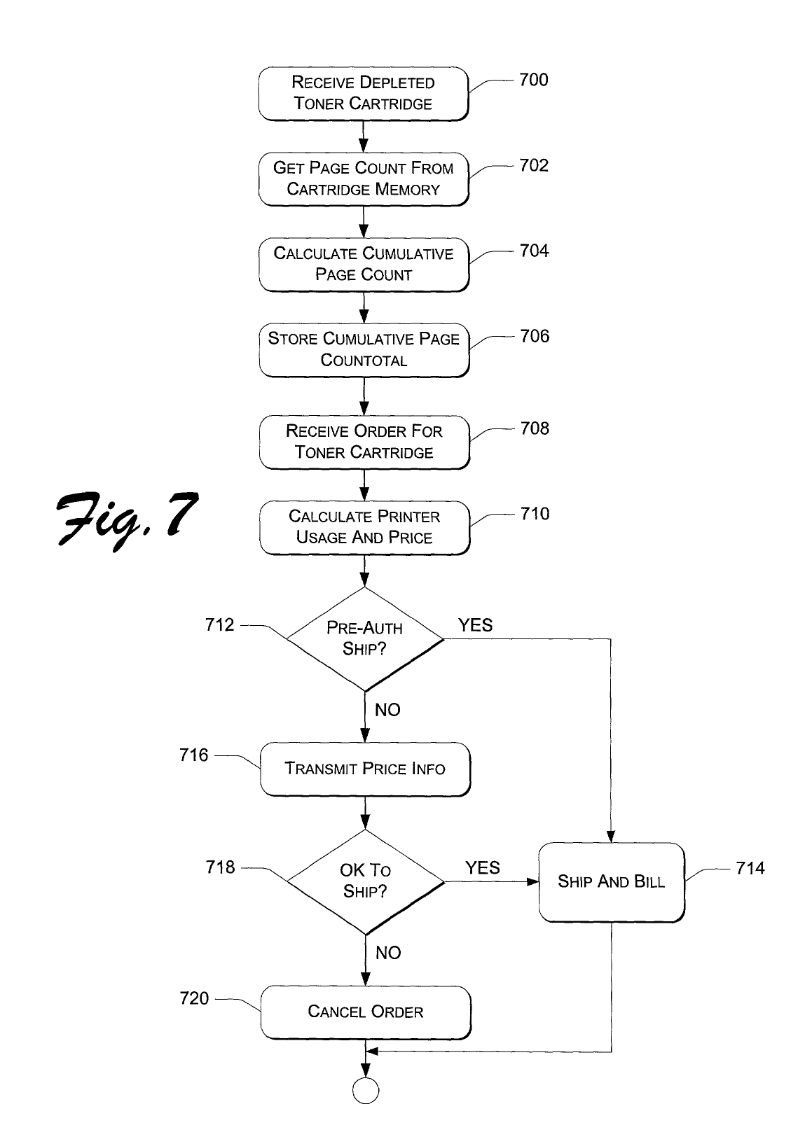

FIG. 6 depicts an exemplary pricing table 600 that is suitable for use with the high-usage incentive pricing systems and methods described herein. The exemplary pricing table 600 includes row 602, row 604, row 606 and row 608. The exemplary pricing table 600 also includes a usage column 610, a discount column 612 and a price column 614. In this example, row 602 stores a value of 5,000 in the usage column 610, a value of 5% in the discount column 612 and a value of $95.00 in the price column 614. This indicates that for a customer that prints 5,000 to 9,999 pages per month with a vendor's components, the customer receives a 5% discount on a toner cartridge or other consumable. In this case, the 5% discount gives a price of $95.00 for the toner cartridge.

Row 604 stores a value of 10,000 in the usage column 610, a value of 7% in the discount column 612 and a value of $93.00 in the price column 614. This indicates that for a customer that prints 10,000 to 14,999 pages per month with a vendor's components, the customer receives a 7% discount on a toner cartridge or other consumable. In this case, the 7% discount gives a price of $93.00 for the toner cartridge.

Similarly row 606 stores a value of 15,000 in the usage column 610, a value of 10% in the discount column 612 and a value of $90.00 in the price column 614. This indicates that for a customer that prints 15,000 to 24,999 pages per month with a vendor's components, the customer receives a 10% discount on a toner cartridge or other consumable. In this case, the 10% discount gives a price of $90.00 for the toner cartridge.

Likewise, row 608 stores a value of 25,000 in the usage column 610, a value of 15% in the discount column 612 and a value of $85.00 in the price column 614. This indicates that for a customer that prints 25,000 pages or more per month with a vendor's components, the customer receives a 15% discount on a toner cartridge or other consumable. In this case, the 15% discount gives a price of $85.00 for the toner cartridge.

The exemplary pricing table 600 is shown and described to provide only one example of a pricing table. However, any of several different configurations of pricing tables may be used. Also, there may be a separate pricing table for each particular toner cartridge and/or printing device component. The function of the pricing table 600 will be described in greater detail below, with respect to the exemplary method depicted in FIG. 7.

Exemplary High-Usage Incentive Pricing Implementations

FIG. 7 is a flow diagram that depicts an exemplary high-use incentive pricing method in accordance with the systems and data structures shown and described above. It is noted that the method depicted in FIG. 7 is but one example of an implementation of such systems and that other implementations may be used in accordance with the present invention(s). In the discussion of FIG. 7, reference will be made to the previous figures and the reference numerals associated therewith.

At block 700, the recycle center 320 of the vendor 300 receives a depleted toner cartridge 316 from the customer enterprise 302. The depleted toner cartridge 316 includes component memory that stores a page count. At block 702, the page count and a customer identifier is read from the component memory. The usage/price calculator 332 retrieves a pages printed value associated with the customer enterprise 302 from the pages printed field 414 of the usage database 400 and calculates a new cumulative page count for the customer enterprise at block 704 by adding the page count retrieved from the depleted toner cartridge 316 to the page count value stored in the pages printed field 414 of the usage database 400 (block 704). The new cumulative page count is then stored in the pages printed field 414 of the usage database 400 at block 706. If a history table 500 is utilized, the date the page count was received and the page count are stored in the history database 500 at this time.

At block 708, an order for a new toner cartridge 318 is received by the vendor 300 from the purchasing department 314 of the customer enterprise 302. The usage/price calculator 332 determines a price for the toner cartridge at block 710. This is done by first determining the printing device usage (also referred to herein as “printer usage”) from a value retrieved from the pages printed field 414 of the usage database 400 and a value retrieved from the usage term field 416 of the usage database 400. The printer usage parameters varies depending upon the implementation. For discussion purposes, the printer usage is described herein as an average-pages-per-month over a one-year period. When the printer usage has been determined, the printer usage is compared to the pricing table 600 to determine a price for the ordered toner cartridge.

At block 712, it is verified whether or not the customer enterprise has pre-authorized shipment of the new 318 toner cartridge without regard for the price. If so (“Yes” branch, block 712), then the new toner cartridge 318 is shipped by the shipping department 324 of the vendor 300 and the customer enterprise 302 is billed for the new toner cartridge by the order center 322 of the vendor 300 (block 714).

If shipment has not been pre-authorized (“No” branch, block 712), then the price is transmitted to the customer enterprise 302. At block 718, the customer enterprise 302 informs the vendor 300 whether or not to ship the new toner cartridge 318. If the customer enterprise 302 authorizes shipment, then the new toner cartridge 318 is shipped and the customer enterprise 302 is billed at block 714. If the customer enterprise does not authorize the order (“No” branch, block 718), then the order is canceled at block 720.

### CONCLUSION

Implementation of the high-usage incentive pricing systems and methods described herein provide a printing device replaceable component vendor a way to gather information to determine which customers use a higher amount of the vendor's products. In return, a customer can receive discounts on necessary consumables. Customers having a high printer usage rate will be able to save a significant amount on the purchase of replacement components.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method, comprising:
detecting the occurrence of a marketing event for a customer, the marketing event regarding one or more printing device replaceable components;
determining printing device usage for the customer;
determining a price for the one or more printing device replaceable components based on the printing device usage; and
transmitting the price to the customer.

2. The method as recited in claim 1, wherein the determining the printing device usage further comprises calculating a number of pages printed by a particular brand of printing devices owned by the customer.

3. The method as recited in claim 1, wherein the determining the printing device usage further comprises calculating a number of pages printed by a particular brand of printing devices owned by the customer over a usage time period.

4. The method as recited in claim 3, wherein usage time period of a moving average.

5. The method as recited in claim 3, wherein the usage time period is a fixed time period.

6. The method as recited in claim 1, wherein the determining the printing device usage further comprises calculating an average number of pages printed per month by a particular brand of printing devices owned by the customer.

7. The method as recited in claim 1, wherein the detecting the occurrence of a marketing event further comprises receiving an order for one or more replaceable components from the customer.

8. The method as recited in claim 1, wherein the detecting the occurrence of a marketing event further comprises receiving an inquiry from the customer for the price of the one or more replaceable components.

9. The method as recited in claim 1, wherein the detecting the occurrence of a marketing event further comprises receiving a depleted toner cartridge from the customer.

10. The method as recited in claim 1, wherein the detecting the occurrence of a marketing event further comprises detecting a predetermined time for transmitting an unsolicited advertisement to the customer.

11. The method as recited in claim 1, wherein:
the detecting the occurrence of a marketing event further comprises receiving a depleted printing device replaceable component from the customer, the depleted printing device replaceable component having component memory integrated therewith;
the determining printing device usage for the customer further comprises retrieving a component page count from the component memory that indicates a number of pages printed using the depleted printing device replaceable component and adding the component page count to a cumulative page count to derive a new cumulative page count, the cumulative page count indicating a total number of pages printed by the customer using a particular brand of printing device replaceable component; and
the determining a price for the one or more printing device replaceable components further comprises determining a price for a printing device replaceable component that is identical to the depleted printing device replaceable component, the price being based on the new cumulative page count.

12. The method as recited in claim 1, wherein the determining a price for the one or more printing device replaceable components further comprises determining a price of one or more presently ordered printing device replaceable components.

13. The method as recited in claim 1, wherein the determining a price for the one or more printing device replaceable components further comprises determining a price of one or more printing device replaceable components that that are available for sale.

14. The method as recited in claim 1, wherein the determining a price further comprises referring to a pricing table to determine a price for the one or more printing device replaceable components as a function of the printing device usage.

15. The method as recited in claim 1, wherein the printing device replaceable component is a laser printer toner cartridge.

16. A system, comprising:
a printing device usage database that stores printing device usage for a plurality of customers, the printing device usage being a number of pages printed by a particular brand of printing devices owned by a customer;
a pricing module;
a usage module configured to calculate printing device usage for each customer;
a pricing module configured to calculate a price of a printing device replaceable component for sale to a customer, the price being dependent upon the customer's printing device usage; and
message transmission means for transmitting the calculated price of the printing device replaceable component to the customer.

17. The system as recited in claim 16, further comprising a recycling center to receive a depleted printing device replaceable component that has component memory integrated therewith and to retrieve a page count from the component memory, the page count indicating a number of pages printed utilizing the printing device replaceable component.

18. The system as recited in claim 16, wherein the message transmission means further comprises a network connection over which the price may be transmitted to the customer.

19. The system as recited in claim 16, further comprising an order center configured to receive a customer order for one or more printing device replaceable components.

20. The system as recited in claim 16, wherein the printing device usage is a number of pages printed from printing devices of a particular brand owned by a customer over a usage time period.

21. The system as recited in claim 20, wherein the usage time period is a moving average.

22. The system as recited in claim 16, wherein the printing device usage is an average number of pages per month printed from a particular brand of printing device owned by a customer.

23. A laser printer that embodies the system as recited in claim 16.

24. One or more computer-readable media containing computer-executable instructions that, when executed by a computer, perform the following steps:
calculating printing device usage for the customer by determining a number of pages printed over a usage time period by printing devices owned by the customer that utilize a particular brand of printing device replaceable component; and
calculating the price of a printing device replaceable component, the price being a function of the printing device usage.

25. The one or more computer-readable media as recited in claim 24, wherein the calculating the price of a printing device replaceable component further comprises utilizing a pricing table that indicates a first prices for the printing device replaceable component when the printing device usage falls within a first range, and a second price for the printing device replaceable component when the printing device usage falls within a second range.

26. The one or more computer-readable media as recited in claim 24, wherein:
the printing device usage is a cumulative printing device usage;
the calculating the printing device usage further comprises adding a page count retrieved from component memory of a depleted printing device replaceable component from the customer to the cumulative page count to derive a new cumulative page count for the customer, the page count indicating a number of pages printed using the printing device replaceable component; and
the calculating the price of the printing device replaceable component further comprises utilizing the new cumulative page count.

27. A laser printer that embodies the one or more computer-readable media as recited in claim 24.
